(19) United States
(12) Patent Application Publication
(10) Pub. No.: US 2026/0219714 A1
(43) Pub. Date: Jul. 30, 2026

(54) ADAPTIVE LIFESPAN MANAGEMENT OF DEVICES

(71) Applicant: Intel Corporation, Santa Clara, CA (US)

(72) Inventors: Garrett CLAY, Beaverton, OR (US); Scott PETERSEN, Tualatin, OR (US); Marcos E. CARRANZA, Portland, OR (US)

(21) Appl. No.: 19/571,133

(22) Filed: Mar. 18, 2026

(51) Int. Cl. G06F 1/20; G06F 1/3206

(52) U.S. Cl. CPC G06F 1/206; G06F 1/3206

(57) ABSTRACT

Examples described herein relate to an interface and first circuitry, coupled to the interface. In some examples, the first circuitry is configured to: determine operating parameters of a second circuitry based on a user specified target lifetime for the second circuitry and cause configuration of the second circuitry based on the operating parameters, wherein the second circuitry comprises one or more of: an accelerator, a memory device, network interface device, or a processor.

A data center houses infrastructure, including networked computers, servers, storage systems, and networking equipment. Data centers act as the backbone of the Internet by storing, processing, and distributing amounts of data for businesses and users. In a data center, devices have a lifespan of usefulness before the devices begin to malfunction or fail. Devices malfunction or fail with increased usage primarily due to physical degradation arising from chemical, electrical, and thermal stress.

### BRIEF DESCRIPTION OF THE DRAWINGS

FIG. 1 depicts an example system.

FIG. 2 shows an example process.

FIG. 3 depicts an example of a relationship between power and/or thermal events and device lifetime.

FIG. 4 depicts an example of adjustment of threshold power and/or thermal levels to manage device lifetime.

FIG. 5 depicts a system.

### DETAILED DESCRIPTION

Cloud Service Providers (CSPs) seek to extend device lifespan beyond manufacturer-recommended replacement schedules to increase return on investment (ROI). However, operating devices longer than their originally intended lifespans leads to unpredictable system reliability, degraded performance, and potential security concerns. Various examples described herein include a system that allows data center administrators to specify a desired lifespan of a device (e.g., years) and adjusts peak power and/or thermal levels permitted to be applied to the device to increase a likelihood that the device meets its target lifetime. The target lifetime can be less than, equal to, or greater than a manufacturer indicated nominal lifetime for the device. Various examples can configure a device operating below its thermal and/or power limits to boost performance when additional performance is requested but also expect to meet a target lifespan. Conversely, various examples configure a device operating above its thermal and/or power limits to reduce performance to attempt to meet its target lifespan. Various examples provide proactive device age-based controls that dynamically balance device performance with device reliability goals based on user-defined device lifetime targets. Various examples can reduce a risk of unexpected device failures and support device sustainability.

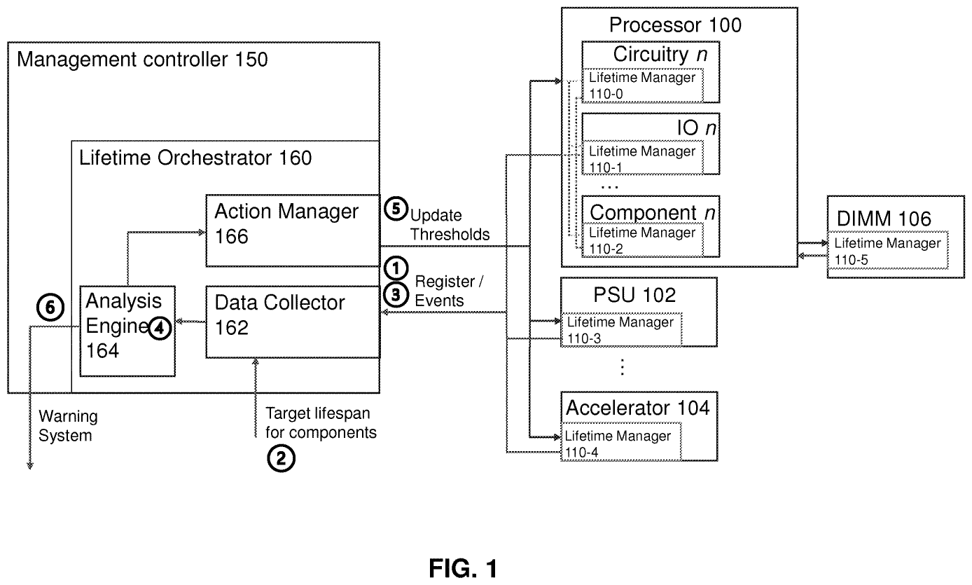

FIG. 1 depicts an example system. Multiple devices can utilize lifetime managers to control threshold power and/or thermal events to control a lifespan of the devices. For example, devices 100, 102, 104, and 106 can include at least: a processor; a central processing unit (CPU); a core; CPU sub-components (e.g., cores, caches, etc.); a memory device (e.g., volatile memory, non-volatile memory, Dual In-line Memory Module (DIMM), or others); a memory controller; a power supply unit (PSU); a storage device; a network interface device; a programmable packet processing pipeline; an accelerator; a hardware queue manager (HQM), an application specific integrated circuit (ASIC); a field programmable gate array (FPGA); a graphics processing unit (GPU); a memory device; a storage device; an interconnect; a host system; a composite server formed from devices connected by a network, fabric, interconnect; or others. Although four devices are shown, more than four devices can be utilized.

Lifetime managers 110-0 to 110-5 can report wear and aging of associated device(s) 100-106, respectively, to management controller 150 or orchestrator 160. Reports of wear and aging can include reporting of physical component age and expected remaining lifespan based on data of device thermal temperatures and/or voltages applied to the device(s). As described herein, based on configurations from action manager 166 that attempt to meet service level agreement (SLA) or performance goals and a lifespan goal for an associated device, lifetime managers 110-0 to 110-5 can cause application of power, voltage, current, and/or temperature limits to associated devices.

Lifetime managers can be part of a single device or communicatively coupled to multiple devices and perform actions requested by orchestrator 160. Lifetime managers can be implemented as a separate circuit from devices or an integrated circuit with one or more devices. Lifetime managers can be implemented as a standardized IP block designed for integration across diverse hardware components including central processing units (CPUs) and their sub-components (e.g., cores, caches, etc.), memory modules, accelerators (e.g., Graphics Processing Units (GPUs), Field-Programmable Gate Arrays (FPGAs), Application-Specific Integrated Circuits (ASICs), or others), power supply units, storage devices, network interface devices, and other aging-sensitive system elements.

Device manufacturers seeking to enable lifespan management capabilities could incorporate lifetime managers into devices to provide an interface for aging-aware control regardless of the underlying device. In cases where not all components include a lifetime manager, the system can operate with partial coverage, managing only those components equipped with lifetime managers while maintaining compatibility with legacy components that lack this capability.

Lifetime orchestrator 160 can register lifetime managers associated with one or more of device(s). Lifetime orchestrator 160 can perform analysis of events from lifetime managers for dynamically adjusting low or high levels of voltage and/or temperature that are permitted to be applied to devices based on user-specified lifespans. In some examples, management controller 150 can execute operations of lifetime orchestrator 160. Management controller 150 can perform management and monitoring capabilities for system administrators to manage and monitor operation at least of devices, such as, a network interface device and storage device, using channels, including in-band channels and out-of-band channels. Out-of-band channels can include packet flows or transmission media that communicate metadata and telemetry. In some examples, management controller 150 can be implemented as one or more of: Board Management Controller (BMC), Intel® Management or Manageability Engine (ME), or other devices.

While examples are described with respect to management controller 150 performing lifetime orchestrator 160, in other examples, an accelerator, processor, or other circuitry can perform lifetime orchestrator 160. Lifetime orchestrator 160 can operate within dedicated compute complexes, hypervisor management layers, cloud orchestration platforms, or standalone management processors. This flexibility allows applicability across different hardware configurations, from edge devices to large-scale datacenter deployments.

Data collector 162 can receive telemetry data (e.g., target lifespan, threshold events, threshold power limits, threshold temperature limits, reported threshold crossing power events, reported threshold crossing temperature events, etc.) from registered lifetime managers for associated devices. Analysis engine 164 can periodically collect data from data collector 162 and determine whether to adjust power and/or temperature threshold levels of one or more devices. For example, analysis engine 164 can configure devices in one or more of: power levels, upper power levels, lower power levels, upper temperature levels, lower temperature levels, or others. Analysis engine 164 can call action manager 166 to adjust device operating parameters based on at least thermal and/or power events that could change a target lifespan of a device. For example, action manager 166 can set for devices one or more of: power levels, upper power levels, lower power levels, upper temperature levels, lower temperature levels, or others. Power supply unit (PSU) 102 can supply a level of voltage and a level of current to one or more of devices based on device specific configurations set by action manager 166.

For example, to determine threshold limits to apply to a device, analysis engine 164 can apply empirical aging models (e.g., electromigration, thermal cycling, peak or maximum power (Pmax) degradation, etc.) to calculate tolerable stress events for the devices. Analysis engine 164 can apply time-series analysis to track degradation trends over configurable time windows (e.g., hourly, daily, weekly, or other time intervals) or apply predictive algorithms including moving averages, exponential smoothing, and regression analysis to forecast a lifespan of a device. Analysis engine 164 can utilize machine learning (ML) models such as neural networks or vector machines to correlate multiple aging factors and environmental conditions to forecast a lifespan of a device. Analysis engine 164 can apply statistical techniques including confidence intervals and risk assessment algorithms to determine threshold adjustments to a device to achieve a target lifespan of a device.

Various examples of operations of analysis engine 164 are described for cases of device overutilization, device underutilization, and on-track utilization. In a case of device overutilization, a number of power and/or temperature upper threshold levels crossed for a particular age of a device is higher than expected and an actual wear of a device is greater than an expected wear. For example, the platform was expected to hit max power or thermal limit, 100 times per month, but the real-world workload involved 120 hits (e.g., exceeded max power of 300 W 120 times instead of 100 times). Analysis engine 164 can interpret this wear as over-utilization for the month. To maintain the target lifespan, analysis engine 164 can reduce the next month's power and/or thermal thresholds (e.g., max power threshold lowered by approximately 17% (50 W)) so that the device stays within its lifetime energy envelope. Other adjustments to power and/or thermal thresholds can be performed. Reducing a power budget and device frequency of a device can reduce a number of permitted times power and/or temperature thresholds are reached can increase an expected lifespan of a device.

In a device underutilization case, a number of power and/or temperature upper threshold levels crossed for a particular age of a device is less than expected and an actual wear of a component is less than an expected wear. For example, if the system expected 100 hits to power and/or thermal limits for the month, but actual usage was only 70 hits, analysis engine 164 can utilize the unused portion of the budget as headroom and increase next month's allowable power and thermal limits achieved (e.g., maximum power threshold increased by 3% (10 W)), such as enabling more turbo duration, potentially higher sustained performance, or looser throttling thresholds. Analysis engine 164 can determine a target lifespan of a device can be reached despite increasing a number of power and thermal limits achieved for a month. Increasing a power budget and device frequency of a device can increase a number of permitted times power and/or temperature thresholds are reached and can decrease an expected lifespan of a device.

In a device on-track utilization case, a number of times a device reaches power and/or thermal limits is within an expected range and analysis engine 164 can maintain power and thermal limits for a next time duration as the lifespan of the device remains as expected. For example, a device on-track utilization case can occur if a projected monthly budget is 100 hits to max power and/or thermal and an actual observed utilization is within tolerance band (e.g., 95-105 hits).

In some examples, a device can operate with lifetime managers disabled, then transition to enabling the lifetime managers after the device reaches a predetermined risk threshold where a number of power and/or thermal limits reached is at or above a configured level, or at a user-defined time interval (e.g., operate normally for 6 months, then enable the lifetime managers). After enablement of a lifetime manager, the lifetime manager can register with lifetime orchestrator 160 and report wear information and potentially receive adjustments to a number of acceptable reached power and/or thermal limits.

The following is an example of application programming interfaces (APIs) or configurations that can be issued for configuring power and/or thermal levels of devices and associated example operations. At (1), lifetime orchestrator can configure lifetime managers for registered devices to periodically retrieve power and/or thermal events and provide the events to data collector 162. For example, lifetime managers can call API register(component_id, nominal_lifespan, [nominal_threshold_x_events], [threshold_x_min/max]) to register with the data collector and define parameters of the devices.

| register(component_id, | |
|---|---|
| nominal_lifespan, | |
| [nominal_threshold_x_events], | |
| [threshold_x_min/max]) | Example description |
| component_id | Identifier of device (e.g., DIMM, |
| | accelerator, processor, etc.) |
| nominal_lifespan | Manufacturer of device indicates |
| | device lifetime. A manufacturer of |
| | the device can specify the nominal |
| | device lifespan. |
| [nominal_threshold_x_events] | Maximum permitted number of power |
| | or thermal events specified by |
| | device manufacturer. |
| [threshold_x_min/max] | Minimum and maximum power and |
| | temperature levels. |

At (2), a user can call an API setComponentLifespan(component_id, lifespan) to set desired lifespans of registered devices with data collector 162.

| setComponentLifespan | |
|---|---|
| (component_id, lifespan) | Example description |
| component_id | Identifier of device (e.g., DIMM, |
| | accelerator, processor, etc.) |
| Lifespan | User-indicated device lifespan. |

In some examples, a user interface (e.g., command line prompt or graphical user interface) can receive an input of a target lifespan for a device. There can be an upper limit to the number of supported years a user can input or a lifetime manager for a device can accept. For example, 5 years can be accepted whereas an input of 500 years may be changed to 10 years. A graphical user interface can warn users if their input lifespan age is outside the supported range. Similarly, there can be a lower limit to support lifespan and the graphical user interface can warn users if their input value for lifespan is too low.

At (3), data collector 162 can periodically call API getEvents(component_id, [threshold_x_events]) to request lifetime managers for registered devices to provide power or thermal events and provide the events to data collector 162.

| getEvents(component_id, | |
|---|---|
| [threshold_x_events]) | Example description |
| component_id | Identifier of device (e.g., DIMM, |
| | accelerator, processor, etc.) |
| threshold_x_events | Number of power or thermal events |
| | that have crossed a threshold over |
| | an amount of time. Example: device |
| | can handle 100 max thermal or power |
| | events in lifetime and device |
| | indicates 10 max thermal events have |
| | occurred since the last report. Max |
| | power or thermal events during a |
| | device lifetime can be determined |
| | by the device manufacturer. |

In some examples, lifetime manager can push or report threshold events to data collector 162. In some examples, lifetime orchestrator 160 can request the threshold events from lifetime managers.

At (4), based on reported number of power and/or thermal threshold events since a last report to data collector from one or more lifetime managers, data collector 162 can provide the reported number of power and/or thermal threshold events to analysis engine 164. Analysis engine 164 can determine whether to adjust a number of power and/or thermal threshold events for associated devices, as described herein.

At (5), based on a decision to adjust a number of power and/or thermal threshold events for an associated device, action manager 166 can call API setThreshold(component_id, [threshold_x_min/max]) to set power and temperature upper and lower threshold levels applied by a lifetime manager for the device.

| setThreshold(component_id, | |
|---|---|
| [threshold_x_min/max]) | Example description |
| component_id | Identifier of device (e.g., DIMM, |
| | accelerator, processor, etc.) |
| threshold_x_min/max | Minimum and maximum power and |
| | temperature levels. Example: |
| | [power_min = 300 W, |
| | power_max = 500 W, |
| | temp_min = 50 F., |
| | temp_max = 140 F.]) |

At (6), for a case where a target lifespan is not expected to be reached, analysis engine 164 can report a warning to a device operator or management controller 150 that the device is expected to fail sooner than its requested lifespan.

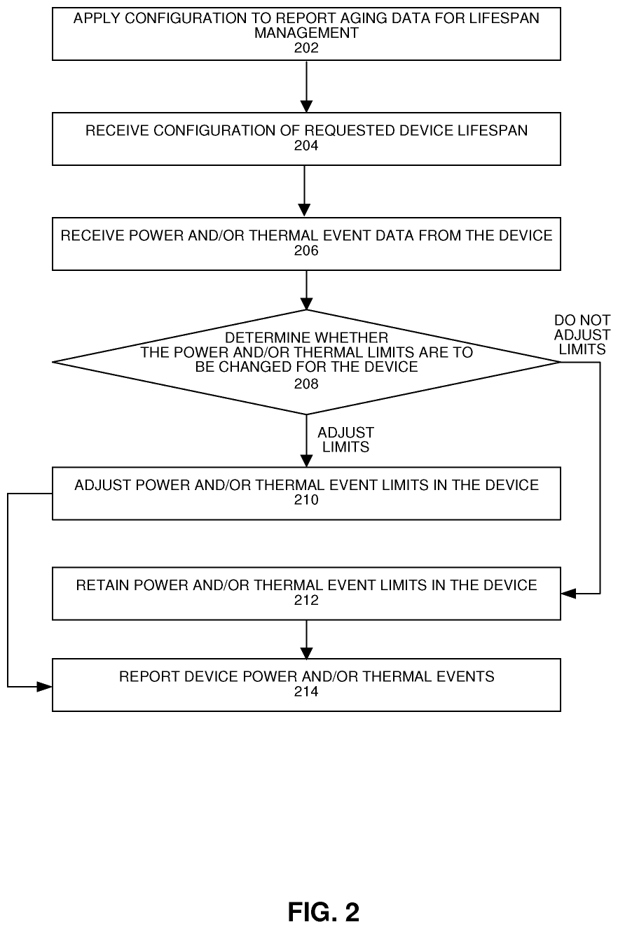

FIG. 2 depicts an example process. At 202, based on a configuration from a data center administrator, orchestrator, and/or management controller, at device boot-up or restart, the device can perform a capability to report a number of times threshold power and/or temperature levels have been met to a lifetime orchestrator and adjust threshold power and/or temperature levels based on a command from lifetime orchestrator. For example, a device 0 can call API register to report to a data collector at least one or more of: component_id=“device 0”, nominal_lifespan=7 years, nominal_threshold_x_events=[power_max_events=100, temp_max_events=200], threshold_x_min/max=[power_min=300 W, power_max=500 W, temp_min=50 F, temp_max=140 F]).

At 204, a data center administrator or orchestrator can specify a target lifespan for registered devices to the lifetime orchestrator. This lifespan can be longer or shorter than the nominal lifespan specified by the device manufacturer. For example, a target lifespan of 10 years for device 0 can be specified by calling API setComponentLifespan(component_id=“core0”, lifespan=10 years). In this example, the target lifespan of 10 years is longer than the device manufacture indicated nominal lifespan of 7 years and within an accepted lifespan range for the device.

At 206, the data collector can receive power and/or thermal events from lifetime managers associated with devices. Power and/or thermal events can include a number of times a device power level or temperature level exceeded a respective power or temperature threshold level specified in action 202. For example, data collector can request aging events from device 0 by periodically calling getEvents(component_id=“device 0”, threshold_x_events=[power_events, thermal_events]).

At 208, analysis engine can monitor threshold events for devices and determine if power and/or temperature level events indicate continued utilization of the device is likely to meet a target lifespan. For example, analysis engine can utilize nominal aging events from device 0 registration and aging events captured to determine whether device 0 is aging at, below, or faster than the target rate. Factors other than power and/or temperature level events can be considered to determine whether the device is expected to meet a target lifespan, such as utilization.

At 210, if device 0 is not aging at the target rate, the analysis engine can trigger the action manager to adjust a permitted number of power and/or thermal events. For example, based on a number of power and/or thermal events exceeding an expected number during a time period and the analysis engine determining that the requested lifespan is not likely to be met, the analysis engine can reduce a number of permitted power and/or thermal events for a next time period and potentially multiple time periods. The time period can be a duration of time from a start up or initial use of the device or a strict subset thereof. For example, action manager can call the lifetime manager of device 0 to lower power and temperature max thresholds by a call to API setThreshold(component_id=“device0”, threshold_x_min/max=[power_max=450 W, temp_max=120 F]).

For example, based on a number of power and/or thermal events being less than an expected number during a time period and the analysis engine determining that the requested lifespan is likely to be met, the analysis engine can increase a number of permitted power and/or thermal events for a next time period or periods to permit the device to increase performance during the next time period or periods. The time period can be a duration of time from a start up or initial use of the device or a strict subset thereof. For example, analysis engine can call the lifetime manager of device 0 to increase power and/or temperature threshold levels by a call to API setThreshold(component_id=“device0”, threshold_x_min/max=[power_max=550 W, temp_max=140 F]).

At 212, based on a number of power and/or thermal events being within a configured expected range during a time period and the analysis engine determining that the requested lifespan is likely to be met, the analysis engine may not change the permitted number of power and/or thermal events during the next time period.

At 214, analysis engine can expose component age to a cluster management (e.g., an orchestrator (e.g., Kubernetes)), a management controller, or other devices or software. For example, when triggered by the analysis engine, the analysis engine can expose an actual age of a device 0 to management controller for higher-level wear-leveling telemetry. The report can indicate whether the device is overutilized, underutilized, or on track in terms of utilization. The device may be replaced if it is expected to fail or degrade in performance sooner than requested or a software or firmware update can be performed on the device to potentially improve device lifespan.

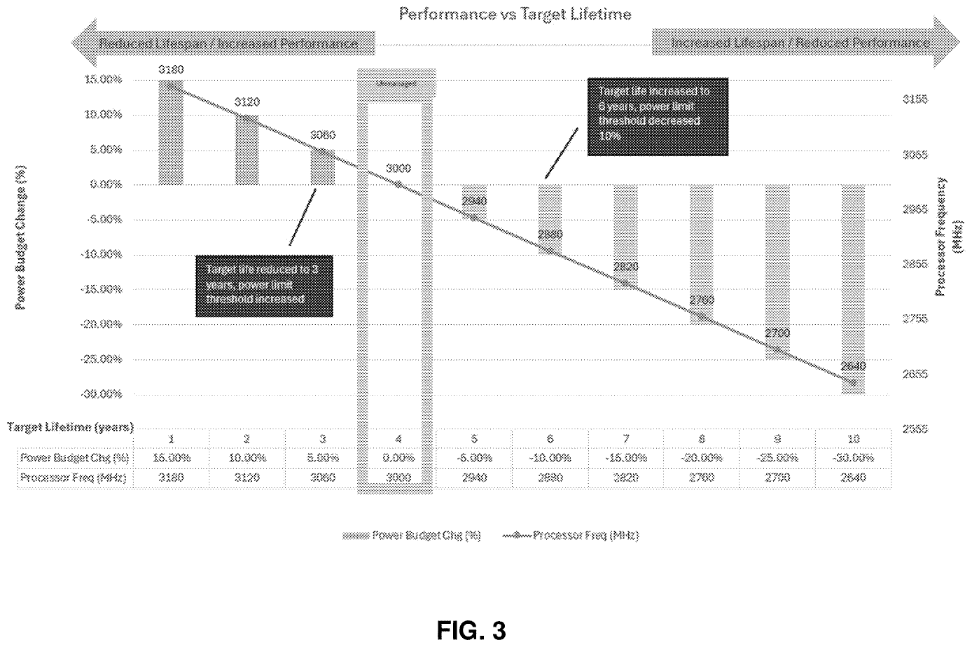

FIG. 3 depicts an example of an expected lifespan of a device changing based on a number of times temperature and/or power threshold levels were reached. In this example, a device has an expected age of 4 years but the age can be reduced to 1 year, or increased to as many as 10 years. Increasing a power budget and device frequency of a device can occur by increasing a number of permitted times power and/or temperature thresholds are reached. However, increasing a number of permitted times power and/or temperature thresholds are reached can reduce an expected lifespan of a device.

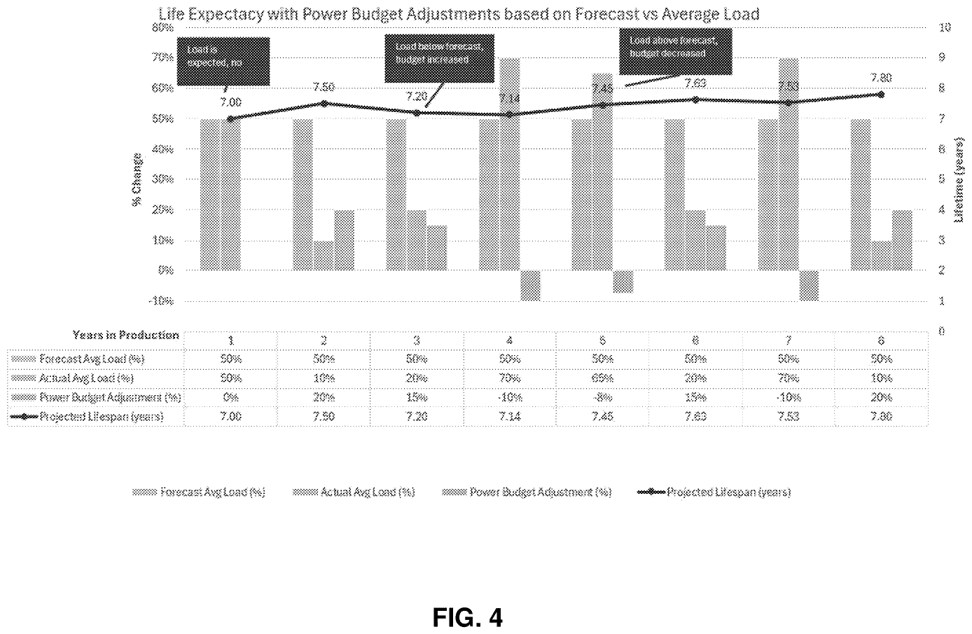

FIG. 4 depicts an example of how active monitoring of the systems load can result in increased or decreased power and thermal budget based on whether the system is under or overutilized. Underutilization from one year can result in an increased power/thermal budget for the next year. Similarly, overutilization from one year can result in decreased power/thermal budget for the next year. In the example, in year 1, a device has been loaded as expected as its average load is within an expected range. In years 2 and 3, the device has been loaded less than expected and the power budget can be increased for years 3 and 4, respectively. In year 4, the device has been loaded more than expected, and the power budget can be decreased for year 5. In year 5, the device has been loaded more than expected, and the power budget can be decreased for year 6. In year 6, the device has been loaded less than expected, and the power budget can be increased for year 7. In year 7, the device has been loaded more than expected, and the power budget can be decreased for year 8. In year 8, the device has been loaded less than expected, and the power budget can be increased for year 9.

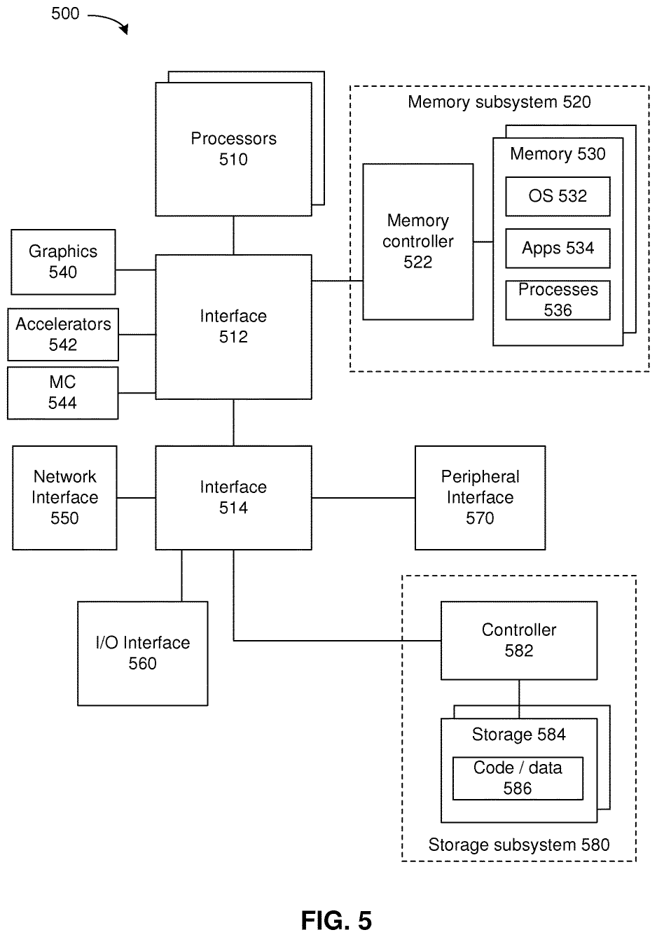

FIG. 5 depicts a system. The system can use examples described herein to control a number of permitted threshold voltage and/or temperature events to manage aging of a device, as described herein. System 500 includes processor 510, which provides processing, operation management, and execution of instructions for system 500. Processor 510 can include any type of microprocessor, central processing unit (CPU), graphics processing unit (GPU), processing core, or other processing hardware to provide processing for system 500, or a combination of processors. Processor 510 controls the overall operation of system 500, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 500 includes interface 512 coupled to processor 510, which can represent a higher speed interface or a high throughput interface for system components that needs higher bandwidth connections, such as memory subsystem 520 or graphics interface components 540, or accelerators 542. Interface 512 represents an interface circuit, which can be a standalone component or integrated onto a processor die.

Accelerators 542 can be a fixed function or programmable offload engine that can be accessed or used by a processor 510. For example, an accelerator among accelerators 542 can provide data compression (DC) capability, cryptography services such as public key encryption (PKE), cipher, hash/authentication capabilities, decryption, or other capabilities or services. In some cases, accelerators 542 can be integrated into a CPU socket (e.g., a connector to a motherboard or circuit board that includes a CPU and provides an electrical interface with the CPU). For example, accelerators 542 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs) or programmable logic devices (PLDs). Accelerators 542 can provide multiple neural networks, CPUs, processor cores, general purpose graphics processing units, or graphics processing units can be made available for use by artificial intelligence (AI) or machine learning (ML) models. For example, the AI model can use or include one or more of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models.

Management controller 544 can perform management and monitoring capabilities for system administrators or orchestrators to manage and monitor operation of circuitry, firmware, and software of system 500. As described herein, management controller 544 can be configured to perform a capability of monitoring aging of devices based on power and/or thermal events and adjust a number of threshold power and/or thermal events to managing aging of the devices. The capability can be enabled or disabled based on a configuration or firmware (e.g., Basic Input/Output System (BIOS), Unified Extensible Firmware Interface (UEFI)). In some examples, a Linux OpenBMC configuration can enable or disable the capability.

Memory subsystem 520 represents the main memory of system 500 and provides storage for code to be executed by processor 510, or data values to be used in executing a routine. Memory subsystem 520 can include one or more memory devices 530 such as read-only memory (ROM), flash memory, one or more varieties of random access memory (RAM) such as static random-access memory (SRAM), dynamic random-access memory (DRAM), or other memory devices, or a combination of such devices. Memory 530 stores and hosts, among other things, operating system (OS) 532 to provide a software platform for execution of instructions in system 500. Additionally, applications 534 can execute on the software platform of OS 532 from memory 530. Applications 534 represent programs that have their own operational logic to perform execution of one or more functions. Processes 536 represent agents or routines that provide auxiliary functions to OS 532 or one or more applications 534 or a combination. OS 532, applications 534, and processes 536 provide software logic to provide functions for system 500. In one example, memory subsystem 520 includes memory controller 522, which is a memory controller to generate and issue commands to memory 530. It will be understood that memory controller 522 could be a physical part of processor 510 or a physical part of interface 512. For example, memory controller 522 can be an integrated memory controller, integrated onto a circuit with processor 510.

In some examples, OS 532 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a CPU sold or designed by Intel®, ARM®, AMD®, Qualcomm®, IBM®, Texas Instruments®, among others.

While not specifically illustrated, it will be understood that system 500 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect (PCI) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 500 includes interface 514, which can be coupled to interface 512. In one example, interface 514 represents an interface circuit, which can include standalone components and integrated circuitry. In one example, multiple user interface components or peripheral components, or both, couple to interface 514. Network interface 550 provides system 500 the ability to communicate with remote devices (e.g., servers or other computing devices) over one or more networks. In some examples, network interface 550 can refer to one or more of: a network interface controller (NIC), a remote direct memory access (RDMA)-enabled NIC, SmartNIC, router, switch, forwarding element, infrastructure processing unit (IPU), data processing unit (DPU), or network-attached appliance.

Network interface 550 can include an Ethernet adapter, wireless interconnection components, cellular network interconnection components, USB (universal serial bus), or other wired or wireless standards-based or proprietary interfaces. Network interface 550 can transmit data to a device that is in the same data center or rack or a remote device, which can include sending data stored in memory.

Some examples of network interface 550 are part of an Infrastructure Processing Unit (IPU) or data processing unit (DPU) or utilized by an IPU or DPU. An xPU can refer at least to an IPU, DPU, GPU, GPGPU, or other processing units (e.g., accelerator devices). An IPU or DPU can include a network interface with one or more programmable pipelines or fixed function processors to perform offload of operations that could have been performed by a CPU. The IPU or DPU can include one or more memory devices. In some examples, the IPU or DPU can perform virtual switch operations, manage storage transactions (e.g., compression, cryptography, virtualization), and manage operations performed on other IPUs, DPUs, servers, or devices.

Some examples of network interface 550 can include a programmable packet processing pipeline with one or multiple consecutive stages of match-action circuitry. The programmable packet processing pipeline can be programmed using one or more of: Protocol-independent Packet Processors (P4), Software for Open Networking in the Cloud (SONiC), Broadcom® Network Programming Language (NPL), NVIDIA® CUDA®, NVIDIA® DOCA™, Data Plane Development Kit (DPDK), OpenDataPlane (ODP), Infrastructure Programmer Development Kit (IPDK), x86 compatible executable binaries or other executable binaries, or others.

In one example, system 500 includes one or more input/output (I/O) interface(s) 560. I/O interface 560 can include one or more interface components through which a user interacts with system 500 (e.g., audio, alphanumeric, tactile/touch, or other interfacing). Peripheral interface 570 can include any hardware interface not specifically mentioned above. Peripherals refer generally to devices that connect dependently to system 500. A dependent connection is one where system 500 provides the software platform or hardware platform or both on which operation executes, and with which a user interacts.

In one example, system 500 includes storage subsystem 580 to store data in a nonvolatile manner. In one example, in certain system implementations, at least certain components of storage 580 can overlap with components of memory subsystem 520. Storage subsystem 580 includes storage device(s) 584, which can be or include any conventional medium for storing large amounts of data in a nonvolatile manner, such as one or more magnetic, solid state, or optical based disks, or a combination. Storage 584 holds code or instructions and data 586 in a persistent state (e.g., the value is retained despite interruption of power to system 500). Storage 584 can be generically considered to be a “memory,” although memory 530 is typically the executing or operating memory to provide instructions to processor 510. Whereas storage 584 is nonvolatile, memory 530 can include volatile memory (e.g., the value or state of the data is indeterminate if power is interrupted to system 500). In one example, storage subsystem 580 includes controller 582 to interface with storage 584. In one example controller 582 is a physical part of interface 514 or processor 510 or can include circuits or logic in both processor 510 and interface 514.

A volatile memory is memory whose state (and therefore the data stored in it) is indeterminate if power is interrupted to the device. A non-volatile memory (NVM) device is a memory whose state is determinate even if power is interrupted to the device.

In an example, system 500 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (RoCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe.

Communications between devices can take place using a network, interconnect, or circuitry that provides chipset-to-chipset communications, die-to-die communications, packet-based communications, communications over a device interface (e.g., PCIe, CXL, UPI, or others), fabric-based communications, and so forth. A die-to-die communications can be consistent with Embedded Multi-Die Interconnect Bridge (EMIB).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner, or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal (e.g., active-low or active-high). The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more later examples and includes an apparatus that includes: an interface and first circuitry, coupled to the interface, wherein the first circuitry is configured to: determine operating parameters of a second circuitry based on a user specified target lifetime for the second circuitry and cause configuration of the second circuitry based on the operating parameters, wherein the second circuitry comprises one or more of: an accelerator, a memory device, network interface device, or a processor.

Example 2 includes one or more earlier or later examples, wherein the configuration of the second circuitry is also based on data concerning wear of the second circuitry, wherein the data concerning wear of the second circuitry comprises utilization of the second circuitry that is based on a number of times power and/or thermal limits were exceeded.

Example 3 includes one or more earlier or later examples, wherein the operating parameters comprise a range of power levels permitted to be applied to the second circuitry and/or a range of permitted thermal temperatures of the second circuitry.

Example 4 includes one or more earlier or later examples, comprising a management controller, wherein the management controller includes the first circuitry.

Example 5 includes one or more earlier or later examples, wherein the user specified target lifetime is different than a manufacturer-specified nominal lifespan for the second circuitry.

Example 6 includes one or more earlier or later examples, wherein based on underutilization of the second circuitry, the operating parameters increase power and/or thermal levels for the second circuitry.

Example 7 includes one or more earlier or later examples, wherein based on overutilization of the second circuitry, the operating parameters reduce power and/or thermal levels for the second circuitry.

Example 8 includes one or more earlier or later examples, and includes at least one non-transitory computer-readable medium comprising instructions stored thereon, that if executed by one or more processors, cause the one or more processors to: determine operating parameters of a circuitry based on a user specified target lifetime for the circuitry and cause configuration of the circuitry based on the operating parameters, wherein the target lifetime is different than a manufacturer-specified nominal lifespan for the circuitry.

Example 9 includes one or more earlier or later examples, wherein the operating parameters of the circuitry is also based on data concerning wear of the circuitry, wherein the data comprises utilization of the circuitry that is based on a number of times power and/or thermal limits were exceeded.

Example 10 includes one or more earlier or later examples, wherein the operating parameters comprise a range of power levels permitted to be applied to the circuitry and/or a range of permitted thermal temperatures of the circuitry.

Example 11 includes one or more earlier or later examples, wherein the one or more processors comprise a management controller.

Example 12 includes one or more earlier or later examples, wherein the circuitry comprises one or more of: an accelerator, a memory device, network interface device, or a processor.

Example 13 includes one or more earlier or later examples, wherein: based on underutilization of the circuitry, the operating parameters increase power and/or thermal levels for the circuitry.

Example 14 includes one or more earlier or later examples, wherein: based on overutilization of the circuitry, the operating parameters reduce power and/or thermal levels for the circuitry.

Example 15 includes one or more earlier or later examples, and includes a method comprising: indicating capability to report wear data of a device and adjust operating parameters of the device; receiving a configuration indicating operating parameters of the device; and applying the configuration to control operating parameters of the device, wherein the operating parameters are to control a lifespan of the device and wherein the lifespan of the device is different than a manufacturer specified lifespan of the device.

Example 16 includes one or more earlier or later examples, wherein the wear data comprises utilization of the device that is based on a number of times power and/or thermal limits were exceeded.

Example 17 includes one or more earlier or later examples, wherein the operating parameters of the device comprise a range of power levels permitted to be applied to the device and/or a range of permitted thermal temperatures of the device.

Example 18 includes one or more earlier or later examples, wherein the device comprises one or more of: an accelerator, a memory device, network interface device, or a processor.

Example 19 includes one or more earlier or later examples, wherein based on underutilization of the device, the operating parameters increase power and/or thermal levels for the device.

Example 20 includes one or more earlier or later examples, wherein based on overutilization of the device, the operating parameters reduce power and/or thermal levels for the device.

1. An apparatus comprising:
an interface and
first circuitry, coupled to the interface, wherein the first circuitry is configured to:
determine operating parameters of a second circuitry based on a user specified target lifetime for the second circuitry and
cause configuration of the second circuitry based on the operating parameters, wherein the second circuitry comprises one or more of: an accelerator, a memory device, network interface device, or a processor.

2. The apparatus of claim 1, wherein the configuration of the second circuitry is also based on data concerning wear of the second circuitry, wherein the data concerning wear of the second circuitry comprises utilization of the second circuitry that is based on a number of times power and/or thermal limits were exceeded.

3. The apparatus of claim 1, wherein the operating parameters comprise a range of power levels permitted to be applied to the second circuitry and/or a range of permitted thermal temperatures of the second circuitry.

4. The apparatus of claim 1, comprising a management controller, wherein the management controller includes the first circuitry.

5. The apparatus of claim 1, wherein the user specified target lifetime is different than a manufacturer-specified nominal lifespan for the second circuitry.

6. The apparatus of claim 1, wherein based on underutilization of the second circuitry, the operating parameters increase power and/or thermal levels for the second circuitry.

7. The apparatus of claim 1, wherein based on overutilization of the second circuitry, the operating parameters reduce power and/or thermal levels for the second circuitry.

8. At least one non-transitory computer-readable medium comprising instructions stored thereon, that if executed by one or more processors, cause the one or more processors to:
determine operating parameters of a circuitry based on a user specified target lifetime for the circuitry and
cause configuration of the circuitry based on the operating parameters, wherein the target lifetime is different than a manufacturer-specified nominal lifespan for the circuitry.

9. The non-transitory computer-readable medium of claim 8, wherein the operating parameters of the circuitry is also based on data concerning wear of the circuitry, wherein the data comprises utilization of the circuitry that is based on a number of times power and/or thermal limits were exceeded.

10. The non-transitory computer-readable medium of claim 8, wherein the operating parameters comprise a range of power levels permitted to be applied to the circuitry and/or a range of permitted thermal temperatures of the circuitry.

11. The non-transitory computer-readable medium of claim 8, wherein the one or more processors comprise a management controller.

12. The non-transitory computer-readable medium of claim 8, wherein the circuitry comprises one or more of: an accelerator, a memory device, network interface device, or a processor.

13. The non-transitory computer-readable medium of claim 8, wherein:
based on underutilization of the circuitry, the operating parameters increase power and/or thermal levels for the circuitry.

14. The non-transitory computer-readable medium of claim 8, wherein:
based on overutilization of the circuitry, the operating parameters reduce power and/or thermal levels for the circuitry.

15. A method comprising:
indicating capability to report wear data of a device and adjust operating parameters of the device;
receiving a configuration indicating operating parameters of the device; and
applying the configuration to control operating parameters of the device, wherein the operating parameters are to control a lifespan of the device and wherein the lifespan of the device is different than a manufacturer specified lifespan of the device.

16. The method of claim 15, wherein the wear data comprises utilization of the device that is based on a number of times power and/or thermal limits were exceeded.

17. The method of claim 15, wherein the operating parameters of the device comprise a range of power levels permitted to be applied to the device and/or a range of permitted thermal temperatures of the device.

18. The method of claim 15, wherein the device comprises one or more of: an accelerator, a memory device, network interface device, or a processor.

19. The method of claim 15, wherein based on underutilization of the device, the operating parameters increase power and/or thermal levels for the device.

20. The method of claim 15, wherein based on overutilization of the device, the operating parameters reduce power and/or thermal levels for the device.
